(19) United States
(12) Patent Application Publication
(10) Pub. No.: US 2025/0101621 A1
(43) Pub. Date: Mar. 27, 2025

(54) PURIFICATION DEVICE FOR REMOVING IMPURITIES FROM A GAS STREAM FROM AN ELECTROLYZER AND A METHOD FOR ITS MANUFACTURE

(71) Applicant: MAHLE International GmbH, Stuttgart (DE)

(72) Inventors: Christoph Steinmetz, Ludwigsburg (DE); Stephan Schick, Stuttgart (DE); Thomas Buehler, Wellendingen (DE); Hannes Marlok, Leonberg (DE)

(21) Appl. No.: 18/793,744

(22) Filed: Aug. 2, 2024

(30) Foreign Application Priority Data
Aug. 4, 2023 (DE) 102023207504.0

(51) Int. Cl. C25B 15/08; B01D 53/26; C25B 1/04; C25B 9/67; C25B 15/021

(52) U.S. Cl. CPC C25B 15/085; B01D 53/265; C25B 1/04; C25B 9/67; C25B 15/021; B01D 2257/80

(57) ABSTRACT

A purification device for removing impurities from a gas stream from an electrolyzer and method of manufacturing a purification device are disclosed. The purification device includes a base housing subdivided into a clean gas chamber and a collecting chamber by a separating device arranged therein for removing impurities from the gas stream. An inflow duct that opens into the collecting chamber. Impurities which accumulate in the collecting chamber as a liquid sump can be removed from the gas stream in the collecting chamber via the separating device, and the purified gas stream can be transferred to the clean gas chamber as a clean gas stream. An outflow duct, which opens into the clean gas chamber. A drainage duct which opens into the collecting chamber for the liquid sump. The inflow duct has a cooling duct section for cooling the gas stream.

### CROSS-REFERENCE TO RELATED APPLICATION

This application claims priority to German Application No. DE 10 2023 207 504.0 filed Aug. 4, 2023, then contents of which are hereby incorporated by reference in its entirety.

### TECHNICAL FIELD

The invention relates to a purification device. The invention relates in particular to a method for manufacturing a corresponding purification device.

### BACKGROUND

Electrolyzers are devices that can produce hydrogen using electrical energy. However, the process in such electrolyzers does not produce pure hydrogen, but a gas stream of hydrogen that carries contaminants such as water vapor and possibly other impurities. These must be separated from the gas stream so that pure, usable hydrogen can be provided.

A corresponding purification device for removing impurities from a gas stream from an electrolyzer of the type mentioned at the beginning is known from GB 2608805 A. It comprises a heat exchanger and a unit connected thereto, which has at least one inlet duct, by means of which the gas stream from the electrolyzer can be fed into the unit, and at least two outlet ducts, wherein the first outlet duct is configured for discharging liquid from the unit and the second outlet duct is configured for discharging a purified gas stream from the unit. The unit also comprises two extraction chambers for removing liquid and/or vapor or decomposition products from the gas stream. The disadvantage of this purification device is that it is made up of a large number of separate components, which means that the purification device has a relatively large number of interfaces and therefore a relatively large number of potential leakage points. The installation of the known purification device is therefore complex and associated with relatively high costs.

The object of the invention is therefore to provide an improved or at least another embodiment of a purification device by means of which impurities can be removed from a gas stream from an electrolyzer. Furthermore, a method for manufacturing a corresponding purification device is to be provided.

### SUMMARY

In the present invention, this task is solved in particular by the objects of the independent claim(s). Advantageous embodiments are the subject of the dependent claims and the description.

The invention has recognized that a purification device for removing impurities from a gas stream from an electrolyzer can be simplified and implemented more cost-effectively by integrally combining the functions necessary for removing impurities from the gas stream in as few components as possible and preferably in just one single unit, rather than using many separate components as has been the case to date.

Accordingly, a purification device for removing impurities from a gas stream from an electrolyzer is proposed, having a solid base housing, in particular of block-shaped design, which defines or forms a recess which is subdivided into a clean gas chamber and a collecting chamber by a separating device of the purification device arranged therein (i.e. in the recess) for removing impurities such as water vapor and/or other impurities from the gas stream. Furthermore, the base housing has an inlet duct running through it, which opens into the collecting chamber and through which the gas stream can be fed into the collecting chamber. In the collecting chamber, the separating device can be used to remove impurities such as water vapor and/or other impurities from the gas stream, which then accumulate in the collecting chamber as a liquid sump. Furthermore, the purified gas stream can be transferred to the clean gas chamber as a clean gas stream using the separating device. It is further provided that the base housing is penetrated by an outflow duct which opens into the clean gas chamber and through which the clean gas stream can be guided out of the clean gas chamber. Furthermore, the base housing has a drainage duct running through it, which opens into the collecting chamber and through which a fluid stream formed by sump liquid from the sump can be led out of the collecting chamber. It is essential for the invention that the inlet duct has a cooling duct section for cooling the gas stream.

This provides an advantageous purification device which is set up to remove impurities such as water vapor and/or other impurities from a gas stream loaded with such impurities from the electrolyzer. In the purification device according to the invention, a cooling function for cooling the gas stream, a separation function for removing impurities from the gas stream and a fluid guide for the gas stream are integrated into the solid base housing. As a result, the proposed purification device has a comparatively small number of components, making it relatively compact and cost-effective. A further advantage resulting from this is that the purification device according to the invention has a comparatively small number of interfaces, so that there are fewer potential leakage points and the assembly of the purification device according to the invention is simplified.

The innovative cooling duct section of the purification device also achieves significant cooling of the gas stream in the inlet duct. Cooling is conveniently realized by transferring a certain amount of heat from the gas stream passing through the inlet duct to the solid base housing. To increase the amount of heat that can be transferred per time (cooling capacity) and/or to cool the base housing, a cooling device described below can be assigned to the base housing. The inventors have recognized that by cooling the gas stream in the inflow duct or in the cooling duct section, a condensation effect can be achieved which causes the contaminants carried in the gas stream, such as water vapor and/or other impurities, to precipitate out of the gas stream in liquid form before it reaches the separating device in the inflow duct or in the cooling duct section. The precipitated liquid is deposited, for example, on a duct wall of the inlet duct or the cooling duct section and/or in droplet form in the gas stream, so that it is then carried along by the gas stream and transported to the collecting chamber. The precipitated liquid can collect there and form the liquid sump or flow into an existing sump. The sump liquid collected in the collecting chamber can be discharged from the purification device at regular, discrete intervals or continuously via the drainage duct.

An electrolyzer within the meaning of the invention is expediently a device for providing a gas stream from gaseous hydrogen, for example by means of electrical energy by electrolysis. The gas stream provided by the electrolyzer, i.e. the gas stream from the electrolyzer, contains process-related contaminants, i.e. undesirable components, according to the following, nonexhaustive list: Water vapor; optional gaseous water; optional liquid water in the form of water droplets; optional other impurities. These must be separated from the gas stream to provide pure, usable hydrogen.

The clean gas stream provided in the clean gas chamber contains, in particular exclusively, hydrogen gas. It can be used in downstream systems. In the collecting chamber, the gas stream from the electrolyzer with the said impurities and the sump of sump liquid are conveniently present at the same time.

The fact that the base housing is solid means that the base housing, with the exception of the components of the purification device described herein, is designed without cavities, i.e. free of cavities. This solid construction improves the stability of the base housing and the ability of the base housing to conduct heat. This has the advantage that the gas stream can be provided with a relative or absolute operating pressure of up to 100 bar, for example, during operation of the purification device and guided through the purification device. In addition, the base housing can transport heat better and absorb a greater amount of heat than non-solid base housings.

The inventors have also recognized that a higher cooling capacity in the cooling duct section, i.e. if a larger amount of heat can be dissipated from this section, the condensation effect explained above can be enhanced.

It can therefore be useful if the cooling duct section extends at least in sections, for example in a meandering shape through the base housing. As a result, the cooling duct section of the inflow duct is relatively elongated compared to a straight version of the cooling duct section, so that the gas stream has to cover a comparatively long distance when flowing through the meandering cooling duct section or the inflow duct. This will take more time than before. A comparatively large amount of heat can be dissipated from the gas stream to the base housing and/or to a cooling device assigned to it. This means that the cooling of the gas stream and/or the base housing is improved. This leads to an intensification of the aforementioned condensation effect in the cooling duct section or in the inflow duct and thus to an increased precipitation of contaminants such as water vapor and/or other impurities in this section.

In this context, it may be expedient if the base housing extends in a main extension direction, wherein the meandering cooling duct section of the inflow duct preferably extends in a depth direction perpendicular to the main extension direction of the base housing over at least 50%, preferably at least 60%, more preferably at least 70% and still more preferably at least 80% and/or at most 90% of a width of the base housing. This provides a preferred embodiment for the purification device, in which the meander-shaped cooling duct section has a preferred size or length, whereby an optimum condensation effect can be achieved.

Another useful feature is that a cooling device acting as a heat sink is assigned to the cooling duct section. The cooling device in question is designed to cool the gas stream and/or the base housing, i.e. to dissipate a predetermined amount of heat from the gas stream and/or the base housing. This enables improved cooling of the gas stream in the cooling duct section of the inlet duct and/or the base housing, thus achieving an improved condensation effect.

The cooling device can be conveniently realized by a coolant duct through the base housing through which a coolant can flow. It is useful if said coolant duct is guided past the cooling duct section of the inflow duct, for example in a meandering shape. A preferred embodiment is one in which the cooling duct section extends through the base housing in a meandering shape, at least in sections, and in which the coolant duct passes through the meandering cooling duct section in a meandering shape. As a result, the cooling duct section and the coolant duct intersect, so that optimum cooling of the gas stream and/or the base housing and an improved condensation effect are achieved. The amount of heat transferred from the gas stream and/or from the base housing to the coolant flowing through the coolant duct can be dissipated with the coolant from the purification device.

It may be provided that said coolant duct is flowed through in counterflow with respect to a flow direction of the gas stream in the inflow duct or in the cooling duct section of the inflow duct. In other words, the flow direction of the gas stream in the inflow duct or in the cooling duct section and a flow direction of the coolant in the coolant duct are oriented in opposite directions to each other. This embodiment can achieve an advantageous, in particular homogeneous heat distribution in the base housing.

Alternatively or additionally, it may be provided that the cooling device is realized by a heat exchanger arranged on the base housing, in particular by a cooling fin arrangement consisting of air-cooled cooling fins arranged on the base housing or a plate heat exchanger with fluid flows arranged on the base housing. This allows a predetermined amount of heat to be absorbed by the gas stream and/or the base housing and, in the case of the cooling fin arrangement, transferred to ambient air, for example, or, in the case of the plate heat exchanger, to a coolant and thus removed from the purification device. The cooling fins can be integral with the base housing, for example. This ensures optimum cooling of the gas stream and/or the base housing and an improved condensation effect.

It is expedient for the base housing to be monolithic. This has the advantage that the base housing has improved stability, particularly compared to non-monolithic base housings, so that the electrolyzer can withstand the relatively high absolute or relative operating pressure of the gas stream of up to 100 bar without difficulty. This design also means that the base housing can be produced using relatively inexpensive manufacturing methods, such as casting, and in large quantities.

It is clear to the skilled person that a monolithic component is a one-piece component, i.e. a component made from a single casting. A “one-piece” component, i.e. a component that has two or more components that are joined in a form-, force- and/or material-locking manner, should be distinguished from this. This means in particular that components that are screwed, clamped, glued or welded together form a “one-piece” assembly.

It is further expedient that the base housing forms a cast housing realized by casting, in particular an aluminum cast housing or preferably an aluminum gravity die-cast housing, wherein the inflow duct and/or the outflow duct and/or the drainage duct are each produced by means of one or more core molds during casting of the base housing. This means that the base housing is made from a single cast, i.e. monolithic. The core molds used for casting can be realized in particular by salt core molds. Corresponding salt core molds can be prepared, for example, by pressing and, after casting the base housing, removed from the cast base housing using simple aids such as water. The use of core molds, in particular salt core molds, when casting the base housing makes it possible to realize the inflow duct and/or the outflow duct and/or the drainage duct—even without chip-removing methods—with a complex shape. Examples of such complex courses are, in particular, meandering courses, for example the optional meandering course of the cooling duct section of the inflow duct, or courses with an undercut. It is understood that the recess of the base housing and/or the said coolant duct of the cooling device can also be produced by means of one or more core molds, in particular one or more salt core molds. Other processes for manufacturing the salt core molds and in the subsequent step of the base housing are generally casting methods with a lost core or lost mold, such as sand cores, 3D printed sand cores or resin cores.

Conveniently, it is provided that said recess of the base housing opens out on an outer top surface of the base housing and is closed in a fluid-tight manner by a lid fixed to the base housing. If the recess in the base housing is designed so that it is open on one side, the separating device can be inserted into the recess relatively easily and without special tools when installing the purification device. This simplifies the manufacture of the purification device. In addition, this design of the recess in the base housing allows relatively uncomplicated maintenance and, if necessary, replacement of the separating device, as access to the separating device is possible via the lid, which in this case is detachably arranged on the base housing, for example by means of a thread.

However, the lid can also be non-detachably attached to the base housing, for example it can be glued or welded to the base housing. In its simplest form, the lid is conveniently realized by a flat, disc-shaped lid body, which is designed to cover the recess of the base housing, which is open on one side, in a fluid-tight manner. For example, sealing rings or sealing cords can be incorporated into the lid body, i.e. as an option, to achieve the aforementioned sealing function.

It is also expedient to provide that the clean gas chamber and the collecting chamber each have a round cylindrical shape and are coaxial with respect to a common central axis, wherein the clean gas chamber and the collecting chamber have different diameters from one another. Furthermore, it is provided that the clean gas chamber merges into the collecting chamber via a circumferential annular step (in relation to the central axis), wherein the separating device is supported on the annular step and is clamped to the annular step via a clamping means for axially fixing the separating device to the base housing, in particular a compression spring. This indicates a preferred embodiment in which the separating device is fixed to the base housing via an annular step and a clamping means. This eliminates the need for additional fasteners to secure the separating device.

According to a further advantageous embodiment, the diameter of the clean gas chamber may be larger than the diameter of the collecting chamber. Furthermore, the separating device is arranged inside the clean gas chamber and is supported radially (in relation to the central axis) on an inner circumferential wall of the clean gas chamber and axially (in relation to the central axis) on the annular step, wherein the clamping means is realized by a compression spring which bears against the lid on the one hand and the separating device on the other hand with clamping force inside the clean gas chamber, so that the separating device is clamped onto the annular step. This means that the separating device is fixed in relation to the base housing so that it is immovable in relation to the base housing even when the purification device is in operation and, in particular, when pressurized by the gas stream. This has the advantage that the gas stream can only pass through the separating device from the collecting chamber to the clean gas chamber. This reliably prevents leakage in this region, i.e. unwanted flow around the separating device by the gas stream and the associated contamination of the clean gas stream of hydrogen gas in the clean gas chamber.

According to a further embodiment, it may be provided that the lid has a head section and a lid base integrally arranged thereon, wherein the lid base has an external thread via which the lid is screwed into a complementary internal thread of the clean gas chamber which bears against the outer top surface of the base housing, so that the lid base is arranged at least partially or completely in the clean gas chamber and the head section is supported in a fluid-tight manner on the base housing, wherein the lid base has an integral lid duct system which passes through the lid base and by means of which the clean gas stream can be guided from the clean gas chamber to the outflow duct.

In a preferred embodiment, it may be expedient if said head section and the in particular round-cylindrical lid base of the lid are coaxially aligned with respect to a main central axis of the lid. The diameter of the head section is conveniently larger than the diameter of the lid base. Furthermore, it may be provided that the said lid duct system of the lid base has a central duct open to the clean gas chamber, which passes through the lid base axially with respect to the main central axis at least in sections or completely, and an annular duct open to the outflow duct, which is introduced on a circumferential surface of the lid base and runs around the lid base in sections or completely in a circumferential direction around the main central axis. Furthermore, the lid duct system has at least one connecting duct that passes through the lid base transversely with respect to the main central axis and fluidically connects the central duct with the annular duct. This provides a preferred embodiment for a lid in which the clean gas stream provided in the clean gas chamber overflows from the clean gas chamber, via the central duct and the at least one connecting duct, into the annular duct, wherein the clean gas stream then passes from the annular duct into the outflow duct and can flow out of the purification device for other use. For example, sealing rings or sealing cords can be incorporated into the head section of the lid, i.e. as an option, to achieve the aforementioned sealing function.

It is expedient that the separating device is realized by a water separator. In a preferred embodiment, the water separator can be realized by a sintered filter, a baffle plate or a cyclone separator. However, the separating device could also be realized by a fabric filter or another filter with a coalescer material.

Furthermore, it may be expedient that a control valve is arranged on the base housing, which is fluidically integrated into the outflow duct and is set up to control the clean gas stream flowing through the outflow duct, and/or a further control valve is arranged on the base housing, which is fluidically integrated into the drainage duct and is set up to control the fluid stream flowing through the drainage duct. The control valve and/or the additional control valve can be passive or active. This means that they can either be actively controlled (active control valve) or they are preset to a fixed switching threshold using a spring, for example. This allows the outflow of the clean gas stream from the outflow duct to be controlled in a targeted manner, thus supplying downstream consumers or equipment with hydrogen. Alternatively or additionally, the sump liquid accumulated in the collecting chamber can be discharged from the purification device at regular, discrete intervals or continuously over time via the drainage duct.

It is expedient that a sensor, in particular a pressure sensor or a temperature sensor or a combined pressure/temperature sensor, is arranged on the base housing to detect a physical variable of the clean gas stream, in particular a pressure and/or a temperature. In particular, this allows the pressure and/or temperature of the clean gas stream to be monitored and the electrolyzer, for example, to be controlled or regulated. The sensor can usefully be fluidically integrated into the outflow duct.

Furthermore, a pressure relief valve that is fluidically integrated into the drainage duct for excess pressure protection can be conveniently arranged on the base housing. The pressure relief valve can be set up in such a way that it opens the drainage duct at a predetermined excess pressure in the drainage duct and/or in the collecting chamber. This allows sump liquid and/or the gas stream to be discharged from the purification device in the event of excess pressure in the discharge duct or collecting chamber, thus protecting the purification device from damage.

Furthermore, it may be provided that the inflow duct opens out at a first connection surface of the outer top surface of the base housing, forming a connection orifice. The connection orifice of the inlet duct is conveniently set up for connecting a supply line, wherein the gas stream from the electrolyzer can be fed to the purification device via the supply line. Furthermore, the connection orifice can be assigned a connection device fixed to the base housing, via which the supply line can be connected. The connection device can be realized, for example, by a screw or plug connection.

It is also possible for the outlet duct to open out at a second connection surface on the outer top surface of the base housing, forming a connection orifice. The second connection surface can be oriented in the opposite direction to the first connection surface. The connection orifice of the discharge duct is conveniently set up for connecting a further supply line, wherein the clean gas stream can be discharged from the purification device via the further supply line. Furthermore, a further connection device fixed to the base housing, via which the further supply line can be connected, can be assigned to the connection orifice of the discharge duct. The additional connection device can be realized, for example, by a screw or plug connection.

Furthermore, it can be provided that the drainage duct opens out at the first or second connection surface of the outer top surface of the base housing, forming a drainage orifice. A drainage connection device can be assigned to the drainage orifice. This can be realized, for example, by a screw or plug connection.

According to a further basic idea of the invention, a method for manufacturing a purification device according to the preceding description is provided. As part of the proposed method, it is envisaged that the inlet duct and/or the outlet duct and/or the drainage duct are each formed by means of one or more core molds during the manufacture of the base housing by casting. For example, a gravity die casting method can be considered as a casting method for the base housing. This means that the inflow duct and/or the outflow duct and/or the drainage duct can each be realized with an almost arbitrarily complex course. Examples of such complex courses are, in particular, meandering courses, for example the optional meandering course of the cooling duct section of the inflow duct, or courses with an undercut. In particular, no machining methods are necessary. The core molds used for casting can be realized in particular by salt core molds. Corresponding salt core molds can be provided cost-effectively by pressing methods, for example, and, after the base housing has been cast, can be removed from the cast base housing using simple aids, such as water. In particular, the base housing can be a cast aluminum housing. Other processes for manufacturing the salt core molds and in the subsequent step of the base housing are generally casting methods with a lost core or lost mold, such as sand cores, 3D printed sand cores or resin cores.

To summarize, it remains to be said: The present invention relates expediently to a purification device for removing impurities from a gas stream from an electrolyzer comprising a base housing which defines a recess which is divided into a clean gas chamber and a collecting chamber by a separating device arranged therein for removing impurities from the gas stream. The base housing has an inlet duct, an outlet duct and a drainage duct. It is essential for the invention that the inlet duct has a cooling duct section for cooling the gas stream. The invention also relates to a method for manufacturing such a purification device.

Other important features and advantages of the invention can be seen from the dependent claims, from the drawings and from the associated description of the figure based on the drawings.

It is understood that the above-mentioned features and those yet to be explained below can be used not only in the combination indicated in each case, but also in other combinations or on their own, without deviating from the scope of the present invention.

Preferred embodiments of the invention are shown in the drawings and are explained in more detail in the following description, wherein identical reference signs refer to identical or similar or functionally identical components.

### BRIEF DESCRIPTION OF THE DRAWINGS

They show, schematically in each case

FIG. 1 a sectional view of a preferred embodiment of a purification device for removing impurities from a gas stream from an electrolyzer,

FIG. 2 a sectional view of the purification device from FIG. 1 along a sectional line A-A drawn in FIG. 1 in the direction of an arrow II,

FIG. 3 a sectional view of the purification device from FIG. 1 along a sectional line B-B drawn in FIG. 1 in the direction of an arrow III,

FIG. 4 a sectional view of a preferred further embodiment of a purification device for removing impurities from a gas stream from an electrolyzer,

FIG. 5 a sectional view of the purification device from FIG. 4 along a sectional line C-C drawn in FIG. 4 in the direction of an arrow V,

FIG. 6 a sectional view of the purification device of FIG. 4 along a sectional line D-D drawn in FIG. 4 in the direction of an arrow VI.

### DETAILED DESCRIPTION

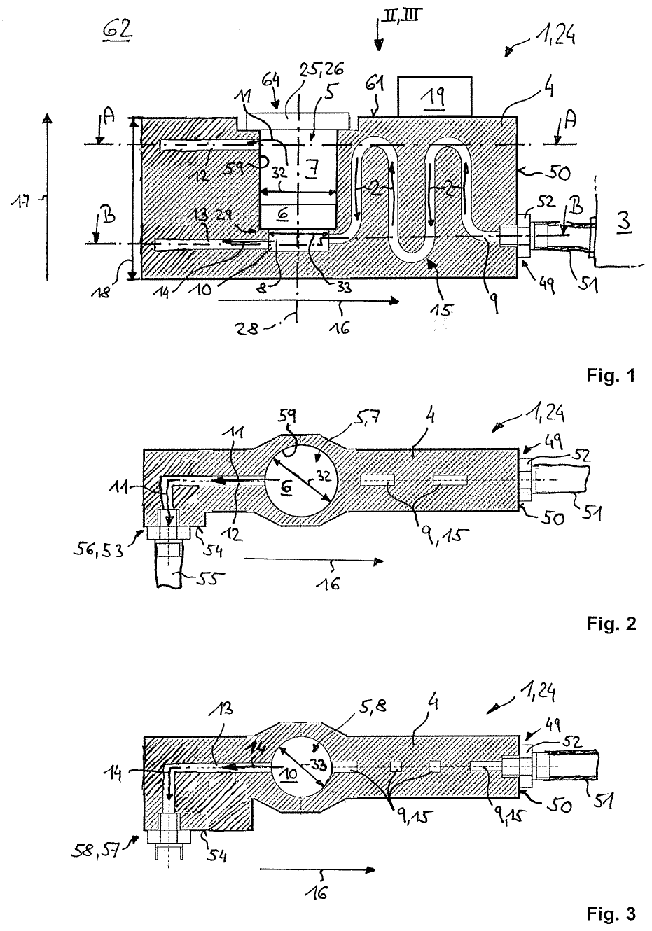

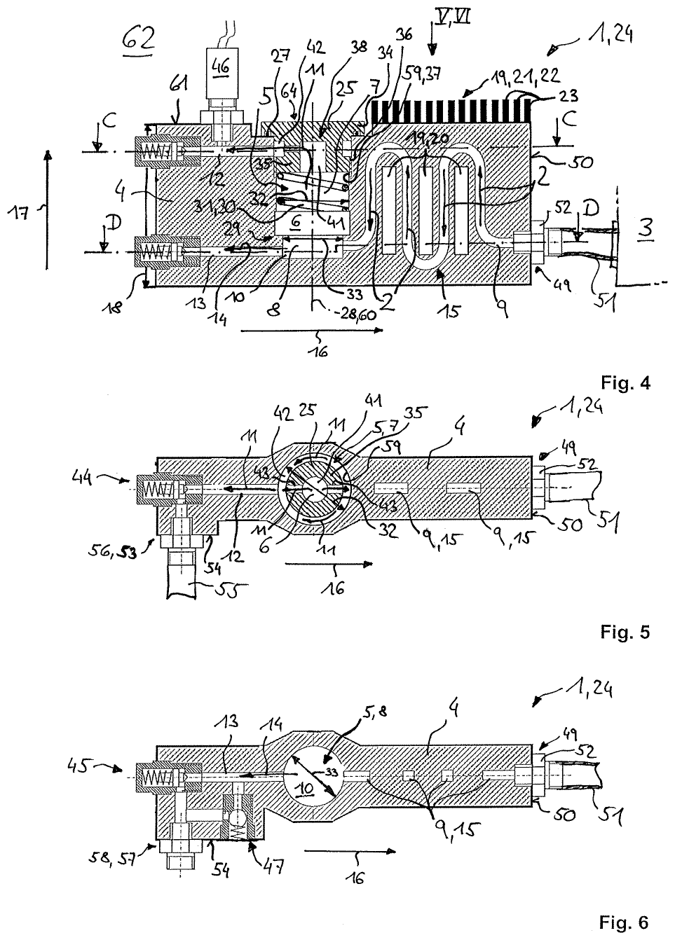

FIGS. 1 through 6 show two preferred embodiments of a purification device, designated in its entirety by the reference numeral 1, for removing impurities from a gas stream 2 from an electrolyzer 3, which is merely indicated in FIGS. 1 and 4.

In the present case, an electrolyzer 3 is a device, not described in detail here, which provides a gas stream 2, indicated by arrows, from gaseous hydrogen, for example by means of electrical energy through electrolysis. The gas stream 2 provided by the electrolyzer 3 contains contaminants, i.e. undesirable components, due to the process, namely water vapor and possibly other impurities. These must be separated from the gas stream 2 to provide pure, usable hydrogen.

The purification device 1 illustrated in FIGS. 1 and 4 has a block-shaped base housing 4 for this purpose. The base housing 4 is solid and monolithic, for example by casting, wherein it is free of cavities with the exception of the components of the purification device 1, which are still explained, and therefore has good stability, so that on the one hand heat can be transported well by the base housing 4 and on the other hand a relatively high, absolute or relative operating pressure of the gas stream 2 of up to 100 bar can be withstood without difficulty. The base housing 4 extends along a main extension direction 16 and has a predetermined width 18 in a depth direction 17 perpendicular to the main extension direction 16. Furthermore, the base housing 4 has an outer top surface 24 facing the surroundings 62, which has at least a first connection surface 50, a second connection surface 54 and a third connection surface 61 connecting the first connection surface 50 to the second connection surface 54. The first connection surface 50 and the second connection surface 54 can each form a narrow end surface and the third connection surface 61 a large longitudinal surface of the base housing 4.

Furthermore, FIGS. 1 and 4 show a recess 5 open on one side, which is delimited or formed by the base housing 4, opens out purely by way of example at the third connection surface 61 of the base housing 4, forming an opening 64, and is closed in a fluid-tight manner by a lid 25 fixed to the base housing 4 at the connection surface 61, which is discussed further below. The recess 5 can be realized, for example, when casting the base housing 4 using a core shape. Alternatively, the recess 5 could be created by a machining method such as drilling or similar.

The recess 5 is divided into a clean gas chamber 7 adjacent to the third connection surface 61 and a collecting chamber 8 by a separating device 6 of the purification device 1 arranged therein and designed to remove impurities from the gas stream 2. The separating device 6, symbolized by a box, can be implemented by a water separator, a sintered filter, a baffle plate, a cyclone separator or a fabric filter and can be inserted into the clean gas chamber 7 through the opening 64 of the recess 5 and, if necessary, removed from the clean gas chamber 7, for example for maintenance purposes.

The clean gas chamber 7 and the collecting chamber 8 of the recess 5 are each round-cylindrical in the present case and are coaxially aligned with respect to a dotted central axis 28. The clean gas chamber 7 and the collecting chamber 8 furthermore have different diameters 32, 33 from one another, wherein, purely by way of example, the diameter 32 of the clean gas chamber 7 is larger than the diameter 33 of the collecting chamber 8, so that, as explained, the separating device 6 can be inserted into or removed from the clean gas chamber 7 through the opening 64 of the recess 5. Due to the different diameters 32, 33, the clean gas chamber 7 merges into the collecting chamber 8 via a circumferential annular step 29 (in relation to the central axis 28). The annular step 29 forms a flat annular surface that is perpendicular to the central axis 28 and is coaxially aligned with respect to it.

The separating device 6 in question is arranged within the clean gas chamber 7 of the recess 5 in such a way that it is supported axially on the annular step 29 with respect to the central axis 28. This means that the separating device 6 is in contact with the annular step 29. It can also be seen here that the separating device 6 is arranged inside the clean gas chamber 7 in such a way that it is supported radially on an inner circumferential wall 59 of the clean gas chamber 7 with respect to the central axis 28. Sealing means can be provided on the annular step 29, which ensure that the gas stream 2 can only flow through the separating device 6 from the collecting chamber 8 to the clean gas chamber 7.

According to the embodiment illustrated in FIG. 4, in contrast to the embodiment illustrated in FIG. 1, it is provided that the separating device 6 is clamped axially (in relation to the central axis 28) on the annular step 29 by a clamping means 30, which is realized in the present case by a reliable and inexpensive compression spring 31. The compression spring 31 is in contact with the lid 25 on the one hand and the separating device 6 on the other with clamping force inside the clean gas chamber 7, so that the separating device 6 is clamped onto the annular step 29. As a result, the separating device 6 is fixed to the base housing 4 so that it cannot lift off the annular step 29 during operation of the purification device 1, which could possibly lead to contamination of the clean gas chamber 7 with the gas stream 2.

The purification device 1 illustrated in FIGS. 1 and 4 also has an inflow duct 9 passing through the base housing 4 for guiding the gas stream 2 into the collecting chamber 8, wherein the inflow duct 9 opens into the collecting chamber 8 and opens out at the first connection surface 50 of the outer top surface 24 of the base housing 4, forming a connection orifice 49. The connection orifice 49 of the inlet duct 9 is conveniently set up for connecting a supply line 51, wherein the gas stream 2 from the electrolyzer 3 can be fed to the purification device 1 via the supply line 51. In the present case, a connection device 52, which is fixed to the base housing 4 and via which the supply line 51 can be connected, is assigned to the connection orifice 49. The connection device 52 can be realized, for example, by a screw or plug connection. During operation of the purification device 1, the gas stream 2 from the electrolyzer 3 provided at the connection orifice 49 can be guided through the base housing 4 to the collecting chamber 8 by means of the inlet duct 9.

In the collecting chamber 8, impurities such as water vapor and/or other impurities can be removed from the gas stream 2 provided in the collecting chamber 8 by means of the separating device 6 arranged there, which then accumulate in the collecting chamber 8 as a liquid sump 10 due to the effect of gravity. The purified gas stream 2 can be transferred to the clean gas chamber 7 as a clean gas stream 11, indicated by arrows, using the separating device 6.

The purification device 1 illustrated in FIGS. 1 and 4 also has an outflow duct 12 passing through the base housing 4 for guiding the clean gas stream 11 out of the clean gas chamber 7, wherein the outflow duct 12 opens into the clean gas chamber 7 on the one hand and on the other hand opens out at the second connecting surface 54 of the outer top surface 24 of the base housing 4, forming a connection orifice 53. The connection orifice 53 of the discharge duct 12 is set up in the present case for connecting a further supply line 55, wherein the clean gas stream 11 can be discharged from the purification device 1 via the further supply line 55. Furthermore, a further connection device 56, which is fixed to the base housing 4 and via which the further supply line 55 can be connected, is assigned to the connection orifice 53 of the outflow duct 12. The further connection device 56 can be realized, for example, by a screw or plug connection.

The purification device 1 illustrated in FIGS. 1 and 4 also has a drainage duct 13 passing through the base housing 4, which on the one hand opens into the collecting chamber 8 and on the other hand opens out at the second connecting surface 54 of the outer top surface 24 of the base housing 4, forming a drainage orifice 57. The sump liquid of the sump 10 collected in the collecting chamber 8 can be discharged from the purification device 1 in the form of a fluid stream 14, which is indicated by arrows, at regular, discrete intervals or continuously over time via the drainage duct 13. A drainage connection device 58 can be assigned to the drainage orifice 57. This can be realized, for example, by a screw or plug connection.

Said ducts, i.e. the inflow duct 9 and/or the outflow duct 12 and/or the drainage duct 13 can preferably be produced by means of one or more core molds during the manufacture of the base housing 4 by casting.

The purification device 1 illustrated in FIGS. 1 and 4 is further characterized by the fact that said inlet duct 9 has a cooling duct section 15 for cooling the gas stream 2. The cooling duct section 15 can be used to achieve significant cooling of the gas stream 2 in the inlet duct 9 or in the cooling duct section 15. The invention has recognized that by cooling the gas stream 2 in the inflow duct 9 or in the cooling duct section 15, a condensation effect can be achieved which causes water vapor and/or other impurities carried in the gas stream 2 to be precipitated out of the gas stream 2 in liquid form before it reaches the separating device 6 in the inflow duct 9 or in the cooling duct section 15. The precipitated liquid is deposited, for example, on a duct wall of the inflow duct 9 or the cooling duct section 15 or in droplet form in the gas stream 2, so that it is then carried along by the gas stream 2 and transported to the collecting chamber 8. The precipitated liquid can collect there and form the liquid sump 10 or flow into the existing sump 10. The sump liquid of the sump 10 collected in the collecting chamber 8 can be discharged from the purification device 1 at regular, discrete intervals or continuously over time via the drainage duct 13.

According to the embodiment illustrated in FIG. 1, it is provided that the cooling duct section 15 extends through the base housing 4 in a meandering manner, at least in sections. Preferably, it is provided that the meandering cooling duct section 15 extends in the depth direction 17 perpendicular to the main extension direction 16 of the base housing 4 over at least 50%, preferably at least 60%, more preferably at least 70% and even more preferably at least 80% and/or at most 90% of the width 18 of the base housing 4. As a result, the cooling duct section 15 of the inflow duct 9 is relatively long, so that the gas stream 2 has to cover a comparatively long distance when flowing through the meandering cooling duct section 15 or the inflow duct 9, which takes a relatively long time. A comparatively large amount of heat can be transferred from the gas stream 2 to the base housing 4, which can increase the aforementioned condensation effect.

According to the embodiment illustrated in FIGS. 1 and 4, it is further provided that a cooling device 19 acting as a heat sink is associated with the cooling duct section 15. The cooling device 19 is designed to cool the gas stream 2 and/or the base housing 4, i.e. to dissipate a predetermined amount of heat from the gas stream 2 and/or from the base housing 4. According to FIG. 4, it is specifically provided that the cooling device 19 is realized by a coolant duct 20 which passes through the base housing 4 and through which a coolant can flow. In the present case, the coolant duct 20 is meander-shaped and passes through the meander-shaped cooling duct section 15 in such a way that the cooling duct section 15 and the coolant duct 20 cross each other. This ensures optimum cooling of the gas stream 2 and/or the base housing 4 and thus an improved condensation effect.

According to FIG. 4, it is also provided that the cooling device 19 has a heat exchanger 21 arranged on the base housing 4 in addition to the coolant duct 20. The heat exchanger 21 is designed purely by way of example as a cooling fin arrangement 22 consisting of air-cooled cooling fins 23 arranged on the outer top surface 24 of the base housing 4, although the heat exchanger 21 could also be realized by a plate heat exchanger through which fluid flows. The cooling fins 23 can, for example, be integral with the base housing 4. It is understood that the cooling device 19 can be realized only by the coolant duct 20 or by the heat exchanger 21. This enables optimum cooling of the gas stream 2 and/or the base housing 4.

It should also be mentioned that the lid 25 according to FIG. 1 is realized by a flat, disc-shaped lid body 26. This can be provided at low cost. The lid body 26 is designed to cover the recess 5 of the base housing 4, which is open on one side, in a fluid-tight manner, for which purpose the lid 25 can have a sealing ring incorporated into the lid body 26, which is not illustrated.

According to the embodiment illustrated in FIG. 4, the lid 25 is formed by a head section 34 and a lid base 35 integrally arranged thereon. The lid base 35 has an external thread 36, via which the lid 25 is screwed into a complementary internal thread 37 of the clean gas chamber 7, which lies against the outer top surface 24 of the base housing 4 and is formed on the inner circumferential wall 59 of the clean gas chamber 7. As a result, the lid base 35 is arranged completely in the clean gas chamber 7, while the head section 34 is supported in a fluid-tight manner on the base housing 4. For this purpose, as in the embodiment shown in FIG. 1, the lid 25 has a sealing ring 27 incorporated in the head section 34. FIG. 4 also shows that the lid 25 has an integral, complex lid duct system 38 at the lid base 35, which penetrates the lid base 35 and is described below and by means of which the clean gas stream 11 can be guided from the clean gas chamber 7 to the outflow duct 12.

With reference to FIG. 4, it should also be explained that the said head section 34 and the in particular round-cylindrical lid base 35 of the lid 25 are coaxially aligned with respect to a main central axis 60 of the lid 25. The diameter of the head section 34 is larger than the diameter of the lid base 35. Furthermore, it is provided that the lid duct system 38 has a central duct 41 which is open towards the clean gas chamber 7 and which passes axially through the lid base 35 completely with respect to the main central axis 60, and an annular duct 42 which is open radially towards the outflow duct 12, is provided on a circumferential surface of the lid base 35 and runs completely around the lid base 35 in a circumferential direction around the main central axis 60. So that the clean gas stream 11 can flow from the clean gas chamber 7 to the outflow duct 12, it is further provided that the lid duct system 38 has connecting ducts 43, which pass through the lid base 35 transversely with respect to the main central axis 60 and fluidically connect the central duct 41 with the annular duct 42. As a result, the clean gas stream 11 provided in the clean gas chamber 7 can flow from the clean gas chamber 7 via the central duct 41 and the at least one connecting duct 43 into the annular duct 42, from wherein the clean gas stream 11 reaches the outflow duct 12 and can flow out of the purification device 1 for other uses.

In contrast to the purification device 1 illustrated in FIG. 1, the purification device 1 illustrated in FIG. 4 is equipped with a sensor 46 arranged on the base housing 4, which may in particular be a pressure sensor or a temperature sensor or a combined pressure/temperature sensor. The sensor 46 is fluidically integrated into the outflow duct 12 so that it can determine a temperature and/or a pressure of the clean gas stream 11 flowing through the outflow duct 12 and provide a corresponding sensor signal. The latter can be used, for example, to control or regulate the electrolyzer 3 or a mass or volume flow of the gas stream 2. It is possible for the purification device 1 to be equipped with further sensors not illustrated, for example with a further sensor that is fluidically integrated into the inflow duct 9, in particular into the cooling duct section 15 of the inflow duct 9, and is set up to determine the temperature and/or pressure of the gas stream 2 flowing through.

Another useful feature in FIG. 4 is that a pressure relief valve 47, which is fluidically integrated into the drainage duct 13, is arranged on the base housing 4 for excess pressure protection. The pressure relief valve 47 is designed to open the drainage duct 13 at a predetermined excess pressure in the drainage duct 13 and/or in the collecting chamber 8, so that in the event of an excess pressure, sump liquid and/or the gas stream 2 can be drained from the purification device 1 and thus the purification device can be protected from damage.

In FIG. 4, it is also expediently provided that a control valve 44 is arranged on the base housing 4, which is fluidically integrated into the outflow duct 12 and is set up to control the clean gas stream 11 flowing through the outflow duct 12. It is also provided that a further control valve 45 is arranged on the base housing 4, which is fluidically integrated into the drainage duct 13 and is set up to control the fluid stream 14 flowing through the drainage duct 13. The control valves 44, 45 can be passive or active, so that a mass or volume flow of the clean gas stream 11 or a mass or volume flow of the fluid stream 14 can be actively controlled or fixed.

1. A purification device for removing impurities from a gas stream from an electrolyzer, comprising:
a solid base housing that defines or forms a recess, the base housing being subdivided into a clean gas chamber and a collecting chamber by a separating device arranged therein for removing impurities from the gas stream,
wherein the base housing is penetrated by an inflow duct that opens into the collecting chamber and through which the gas stream can be guided into the collecting chamber,
wherein impurities which accumulate in the collecting chamber as a liquid sump can be removed from the gas stream in the collecting chamber via the separating device, and the purified gas stream can be transferred to the clean gas chamber as a clean gas stream,
wherein the base housing is penetrated by an outflow duct, which opens into the clean gas chamber and through which the clean gas stream can be guided out of the clean gas chamber,
wherein the base housing is traversed by a drainage duct which opens into the collecting chamber and through which a fluid stream formed by sump liquid from the sump can be guided out of the collecting chamber,
the inflow duct has a cooling duct section for cooling the gas stream.

2. The purification device according to claim 1, wherein
the cooling duct section extends through the base housing in a meandering manner, at least in sections.

3. The purification device according to claim 1, wherein
a cooling device acting as a heat sink is assigned to the cooling duct section.

4. The purification device according to claim 3, wherein
the cooling device includes a coolant duct which passes through the base housing and through which a coolant can flow.

5. The purification device according to claim 3, wherein
the cooling device includes a heat exchanger arranged on the base housing or a plate heat exchanger through which fluid flows arranged on the base housing.

6. The purification device according to claim 1, wherein
the base housing is monolithic.

7. The purification device according to claim 1, wherein
the base housing forms a cast housing realized by casting, and
wherein the inflow duct and/or the outflow duct and/or the drainage duct are each formed by one or more core molds during casting of the base housing.

8. The purification device according to claim 1, wherein
said recess of the base housing opens out at an outer top surface of the base housing and is closed in a fluid-tight manner by a lid fixed to the base housing.

9. The purification device according to claim 1, wherein
the clean gas chamber and the collecting chamber are each round-cylindrical in shape and coaxial with respect to a common central axis,
wherein the clean gas chamber and the collecting chamber have different diameters,
wherein the clean gas chamber merges into the collecting chamber via a circumferential annular step,
wherein the separating device is supported on the annular step and clamped to the annular step via a clamp for axially fixing the separating device to the base housing.

10. The purification device according to claim 9, wherein
the diameter of the clean gas chamber is larger than the diameter of the collecting chamber,
the separating device is arranged inside the clean gas chamber and is supported radially on an inner circumferential wall of the clean gas chamber and axially on the annular step,
wherein the clamp includes a compression spring, which bears against a lid coupled to the base housing on the one hand and the separating device on the other hand with clamping force inside the clean gas chamber, so that the separating device is clamped on the annular step.

11. The purification device according to claim 8, wherein
the lid has a head section and a lid base integrally arranged thereon,
wherein the lid base has an external thread, via which the lid is screwed into a complementary internal thread of the clean gas chamber, which is in contact with the outer top surface of the base housing, so that the lid base is arranged at least partially or completely in the clean gas chamber and the head section is supported in a fluid-tight manner on the base housing,
wherein the lid base has an integral lid duct system passing through the lid base, via which the clean gas stream can be guided from the clean gas chamber to the outflow duct.

12. The purification device according to claim 1, wherein
the separating device is a water separator.

13. The purification device according to claim 1, further comprising:
a control valve arranged on the base housing, which is fluidically integrated into the outflow duct and is set up to control the clean gas stream flowing through the outflow duct, and/or
a further control valve arranged on the base housing, which is fluidically integrated into the drainage duct and is set up to control the fluid stream flowing through the drainage duct.

14. The purification device according to claim 1, further comprising
a sensor is arranged on the base housing for detecting a physical variable of the clean gas stream.

15. A method for manufacturing a purification device according to claim 1, comprising:
forming the inflow duct and/or the outflow duct and/or the drainage duct via one or more core molds during manufacture of the base housing by casting.

16. The purification device according to claim 3, wherein the cooling device includes a cooling fin arrangement comprising air-cooled cooling fins arranged on the base housing.

17. The purification device according to claim 4, wherein the cooling device further includes a plate heat exchanger through which fluid flows arranged on the base housing.

18. The purification device according to claim 9, wherein the clamp is a compression spring.

19. The purification device according to claim 14, wherein the sensor is a pressure sensor or a temperature sensor or a combined pressure/temperature sensor for detecting a pressure and/or a temperature of the clean gas stream.

20. The purification device according to claim 14, further comprising a control valve arranged on the base housing that controls the clean gas stream flowing through the outflow duct.
